(19) United States
(12) Patent Application Publication
(10) Pub. No.: US 2015/0267905 A1
(43) Pub. Date: Sep. 24, 2015

(54) FASTENING DEVICE FOR LAMP APPARATUS AND FASTENING DEVICE FOR APPARATUS INSTALLED ON CEILING

(71) Applicant: Doo Yong Lee, (US)

(72) Inventors: Doo Yong Lee, Uiwang-si (KR); In Seong Kim, Anyang-si (KR)

(21) Appl. No.: 14/416,746

(22) PCT Filed: Jul. 25, 2013
(86) PCT No.: PCT/KR2013/006655

§ 371 Date: Jan. 23, 2015

(30) Foreign Application Priority Data
Jul. 27, 2012 (KR) 10-2012-0082455
Jun. 18, 2013 (KR) 10-2013-0069967

(51) Int. Cl. F21V 21/04; F21S 8/02

(52) U.S. Cl. CPC F21V 21/048; F21S 8/026; F21Y 2101/02

(57) ABSTRACT

Provided is a fastening device for fixing an apparatus such as a lamp installed on a ceiling to a ceiling channel. The fastening device may be commonly installed on ceilings having various structures and has a simplified structure.

### FIELD OF THE INVENTION

The inventive concept relates to a lamp fastening device and a fastening device for a ceiling installation apparatus, and more particularly, to a lamp fastening apparatus and a fastening device for a ceiling installation apparatus, which may be installed commonly on ceilings having various structures and may have a simplified structure.

### DESCRIPTION OF THE RELATED ART

A lamp for illuminating indoors is generally provided on a ceiling, and the ceiling may include various ceiling channels for forming a framework. Therefore, a lamp may be installed in various ways according to kinds of ceiling channels, according to the prior art.

The ceiling channels may be classified as an M bar having an M-shape, a T bar having a T-shape, and a clip bar formed as a clip, according to a cross-sectional shape of the ceiling channel. The M bar, the T bar, and the clip bar have different shapes and structures from each other, and accordingly, different fastening devices corresponding to the kinds of the ceiling channels have been used to install the lamp on the ceiling according to the prior art.

However, if the lamp is fixed in different ways according to the kinds of the ceiling channels, the kind and shape of the ceiling panel have to be considered every time when the lamp is fixed onto the ceiling. Thus, working efficiency of fastening the lamp is degraded.

Also, if various kinds of lamp fastening devices according to the kinds of the ceiling panels have to be prepared, manufacturing costs of the lamp fastening devices increase.

### DETAILED DESCRIPTION OF THE INVENTION

### Technical Problem

The inventive concept provides a lamp fastening device and a fastening device of a ceiling installation apparatus that may be commonly installed on ceilings having various structures and may have a simplified structure.

### Technical Solution

According to an aspect of the present invention, there is provided a lamp fastening device for fixing a lamp on a ceiling channel, the lamp fastening device including: a housing formed as a hollow container that is fixed on the lamp and having a side opening between opposite ends thereof; an operating member including a shaft portion provided in the housing to be rotatable and elevatable, and a hook portion extending from the shaft portion to outside of the housing through the side opening to be hooked onto the ceiling channel according to a rotating operation of the shaft portion; and an elastic member for providing the operating member with an elastic force in a direction in which the hook portion presses the ceiling channel.

A tool recess to which a tool for rotating the operating member is coupled may be formed in a lower end of the shaft portion, and a tool insertion hole for inserting the tool into the housing may be formed in a lower end of the housing, which corresponds to the tool recess.

The shaft portion may include a smaller diameter portion into which the elastic member is inserted, and a larger diameter portion having a greater diameter than the smaller diameter portion to support a lower end of the elastic member, a guide hole for guiding an elevation operation of the shaft portion may be disposed in an upper end of the housing, and an upper end of the elastic member may be supported by an upper inner surface of the housing around the guide hole.

The operating member may further include a connection portion for connecting the shaft portion to the hook portion, the shaft portion may enter the housing through the lower end of the housing, and a side wall of the housing may include a slit that is connected to the side opening so that the connection portion may pass therethrough when the shaft portion enters the housing from the lower end of the housing.

A pair of rotation restriction recesses may be disposed in the side wall of the housing at opposite sides of the slit so that the connection portion is inserted therein from the side opening in order to restrict the rotating operation of the operating member, and one of the pair of rotation restriction recesses may restrict the rotating operation of the operating member that is in an unhooked state where the operating member is released from the ceiling channel, and the other of the pair of rotation restriction recesses may restrict the rotating operation of the operating member that is in a hooked state where the operating member is hooked onto the ceiling channel.

The hook portion may include a plurality of hook boards that are disposed in an elevating direction of the shaft portion and are respectively hooked onto the ceiling channels that are of different types, and an uppermost hook board from among the plurality of hook boards in the elevating direction may have the longest extending length.

The shaft portion and the hook portion of the operating member may be integrally formed with each other.

The housing may include at least one support surface supported by a surface of the lamp in a state of being fixed on the lamp and opened to outside.

The shaft portion may be shorter than the housing and may be elevated in the housing, the elastic member may include a compression spring installed in the housing in a length direction of the housing so that an upper end thereof is supported by the upper inner surface of the housing and a lower end thereof is supported by the shaft portion, and the lower end of the elastic member may be inserted into a support recess formed in the upper end of the shaft portion.

The elastic member may apply an elastic force to the operating member for rotating the operating member in one of a direction in which the hook portion is to be hooked onto the ceiling channel and a direction in which the hook portion is to be unhooked from the ceiling channel.

According to an aspect of the present invention, there is provided a fastening device for fixing an apparatus to a ceiling channel, the fastening device including: a housing formed as a hollow container that is fixed on the apparatus and having a side opening between opposite ends thereof; an operating member including a shaft portion provided in the housing to be rotatable and elevatable, and a hook portion extending from the shaft portion to outside of the housing through the side opening and switched to a state of being hooked onto the ceiling channel and to a state of being unhooked from the ceiling channel according to a rotating operation of the shaft portion; and an elastic member for providing the operating member with an elastic force in a direction in which the hook portion presses the ceiling channel.

A tool recess to which a tool for rotating the operating member is coupled may be formed in a lower end of the shaft portion, and a tool insertion hole for inserting the tool into the housing may be formed in a lower end of the housing, which corresponds to the tool recess.

The operating member may further include a connection portion for connecting the shaft portion to the hook portion, the shaft portion may enter the housing through the lower end of the housing, and a side wall of the housing may include a slit that is connected to the side opening so that the connection portion may pass therethrough when the shaft portion enters the housing from the lower end of the housing.

A rotation restriction recesse may be provided in the housing so that the connection portion is inserted therein from the slit in order to restrict the rotating operation of the operating member. The rotation restriction recess may include a first rotation restriction recess for restricting the rotating operation of the operating member that is unhooked from the ceiling channel. The rotation restriction recess may include a second rotation restriction recess for restricting the rotating operation of the operating member that is hooked onto the ceiling channel.

The operating member may escape from the rotation restriction recess by being elevated in a direction opposite to the direction of the elastic force of the elastic member to rotate to a state of being hooked onto the ceiling channel and a state of being unhooked from the ceiling channel.

The hook portion may include a plurality of hook boards that are disposed in an elevating direction of the shaft portion and may be respectively hooked onto the ceiling channels that are of different types, and an uppermost hook board from among the plurality of hook boards in the elevating direction may have the longest extending length.

The elastic member may apply an elastic force to the operating member for rotating the operating member in one of a direction in which the hook portion is to be hooked onto the ceiling channel and a direction in which the hook portion is to be unhooked from the ceiling channel.

According to an aspect of the present invention, there is provided a fastening device for fixing an apparatus to a ceiling channel, the fastening device including: a frame, to which a main body of the apparatus is mounted, having a shape corresponding to a shape of an installation hole of a ceiling; a housing fixed on the frame; an operating member including a shaft portion provided in the housing to be rotatable and elevatable, and a hook portion extending from the shaft portion and switched to a state of being hooked onto the ceiling channel and to a state of being unhooked from the ceiling channel according to a rotating operation of the shaft portion; and an elastic member for providing the operating member with an elastic force in a direction in which the hook portion is compressed toward the ceiling channel, wherein a tool recess may be formed in a lower end of the shaft portion, a lower end of the housing is opened to expose the tool recess, and a through hole may be formed in the frame so that a tool for elevating and rotating the operating member is coupled to the tool recess.

### Advantageous Effects

According to an aspect of the inventive concept, a lamp fastening device and a fastening device for an apparatus installed on a ceiling only include a housing, an operating member, and an elastic member, each configuring a single body, and thus, may have a simplified structure. In addition, the lamp and the apparatus installed on the ceiling may be commonly hooked and fixed by ceiling channels having various structures only by a rotating operation and an elevation operation of the operating member.

### DESCRIPTION OF THE DRAWINGS

FIG. 1 is a perspective view of a structure in which a lamp assembled with a lamp fastening device according to an exemplary embodiment of the inventive concept is located below an installation hole of a ceiling;

FIG. 2 is an exploded perspective view of the lamp fastening device according to an exemplary embodiment of the inventive concept;

FIG. 3 is a perspective view of the lamp fastening device according to an exemplary embodiment of the inventive concept, in a state where a shaft portion of an operating member is being inserted in a housing;

FIG. 4 is a perspective view of the lamp fastening device according to an exemplary embodiment of the inventive concept, in a state where a rotating operation of the operating member is restricted;

FIG. 5 is a base view of the lamp fastening device according to an exemplary embodiment of the inventive concept;

FIG. 6 is a cross-sectional view of the lamp fastening device according to an exemplary embodiment of the inventive concept, particularly showing an internal structure of the housing;

FIG. 7 is a plan view showing a structure in which the lamp assembled with the lamp fastening device according to an exemplary embodiment of the inventive concept is fixed on an installation hole of the ceiling;

FIG. 8 is a side view showing a structure in which the lamp is fixed on a ceiling panel of an M-bar type by using the lamp fastening device according to an exemplary embodiment of the inventive concept; FIG. 9 is a side view showing a structure in which the lamp is fixed on a ceiling channel of a T-bar type via the lamp fastening device according to an exemplary embodiment of the inventive concept;

FIG. 10 is a side view showing principal elements in a structure, in which the lamp is fixed on a ceiling channel of a clip-bar type via the lamp fastening device, according to an exemplary embodiment of the inventive concept;

FIG. 11 is a side view showing principal elements in a structure, in which the lamp is directly hung by an installation hole formed on the ceiling via the lamp fastening device, according to an exemplary embodiment of the inventive concept;

FIG. 12 is an exploded perspective view of a lamp fastening device according to an exemplary embodiment of the inventive concept;

FIG. 13 is a cross-sectional view of the lamp fastening device according to an exemplary embodiment of the inventive concept;

FIG. 14 is an exploded perspective view of a lamp fastening device according to an exemplary embodiment of the inventive concept;

FIG. 15 is a planar cross-sectional view of a lamp fastening device according to an exemplary embodiment of the inventive concept; and

FIGS. 16, 17, and 18 are diagrams showing examples of fixing a ventilator, an air cooler/heater, and a speaker on a ceiling channel by using the fastening device shown in FIG. 1 through FIG. 15.

### MODE OF THE INVENTION

Hereinafter, the inventive concept will be described more fully with reference to the accompanying drawings, in which exemplary embodiments of the inventive concept are shown. This inventive concept may, however, be embodied in many different forms and should not be construed as limited to the exemplary embodiments set forth herein. Rather, these embodiments are provided so that this disclosure will be thorough and complete, and will fully convey the scope of the invention to one of ordinary skill in the art. Components that are irrelevant to the essence of the inventive concept are omitted from drawings, and widths, lengths, and thicknesses of components in the drawings may be exaggerated for convenience of explanation. Like reference numerals in the drawings denote like elements.

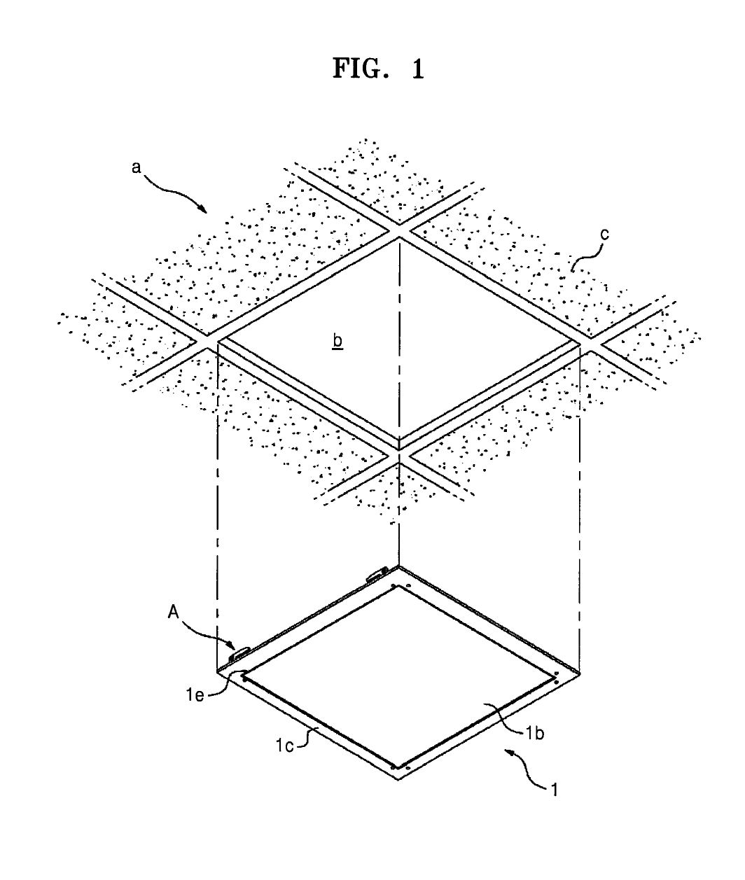

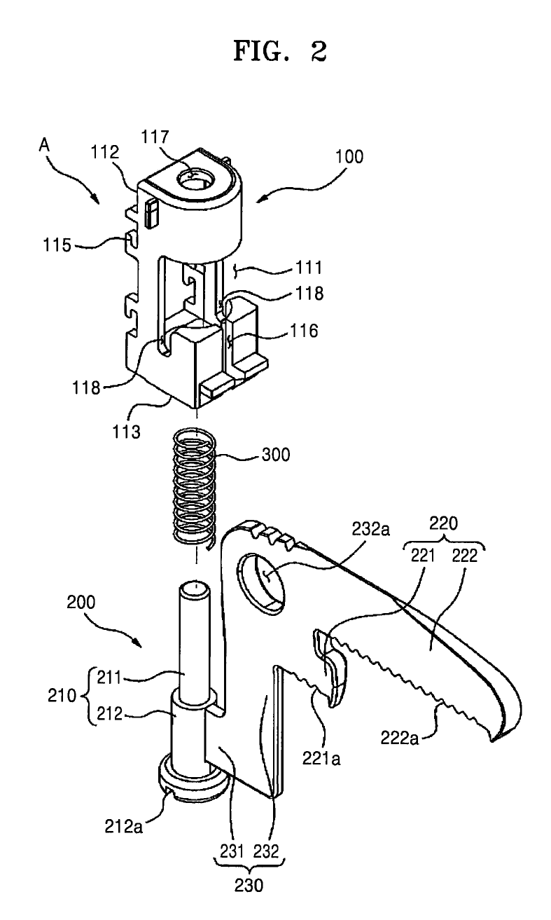

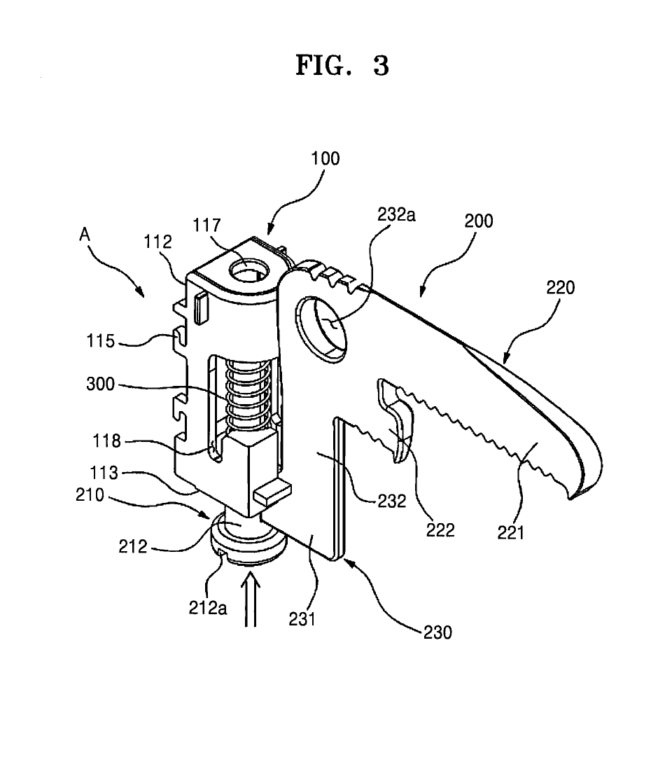

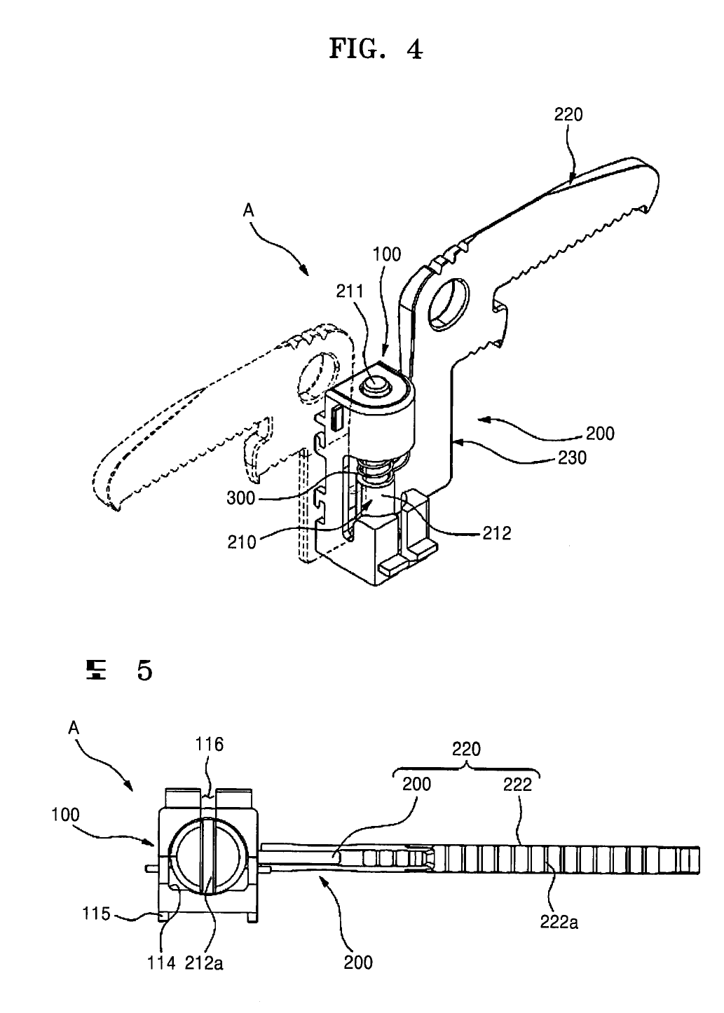

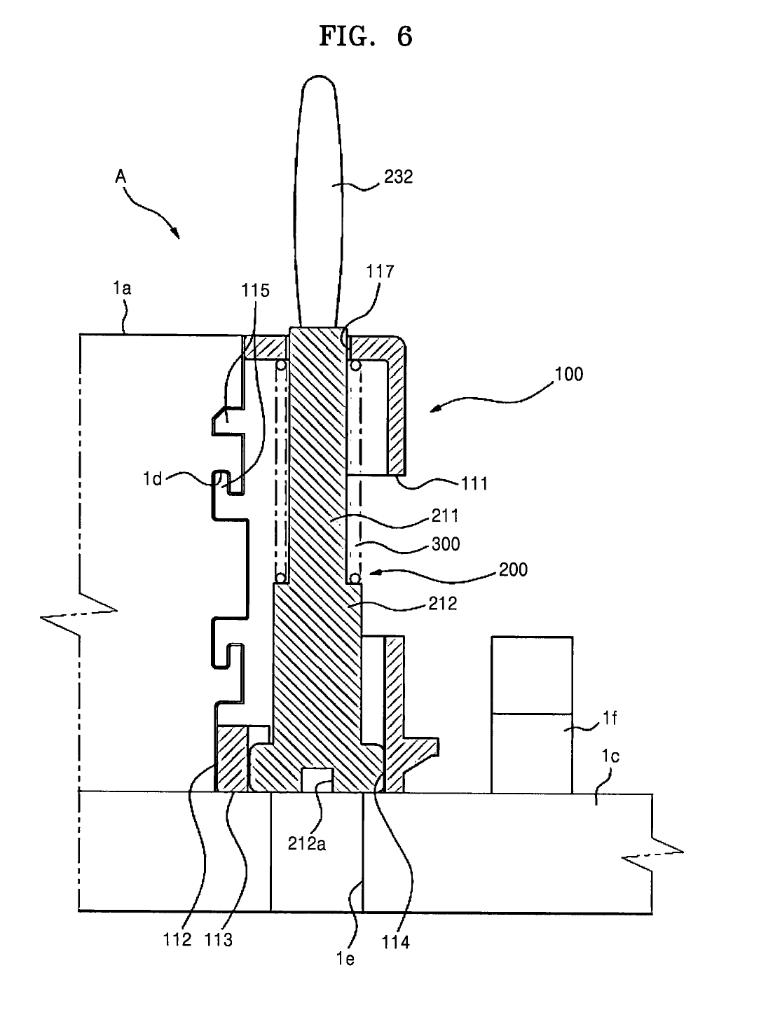

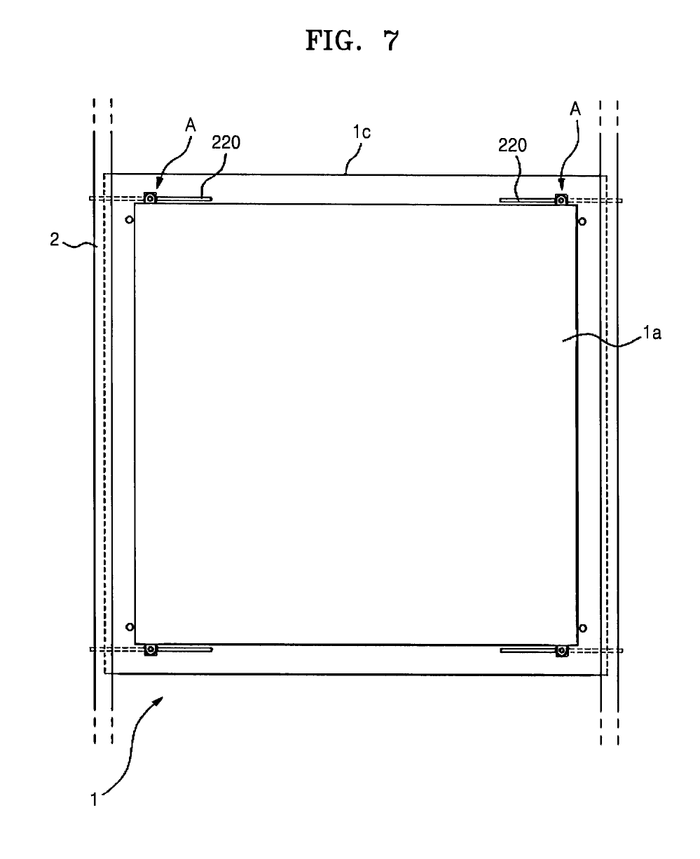

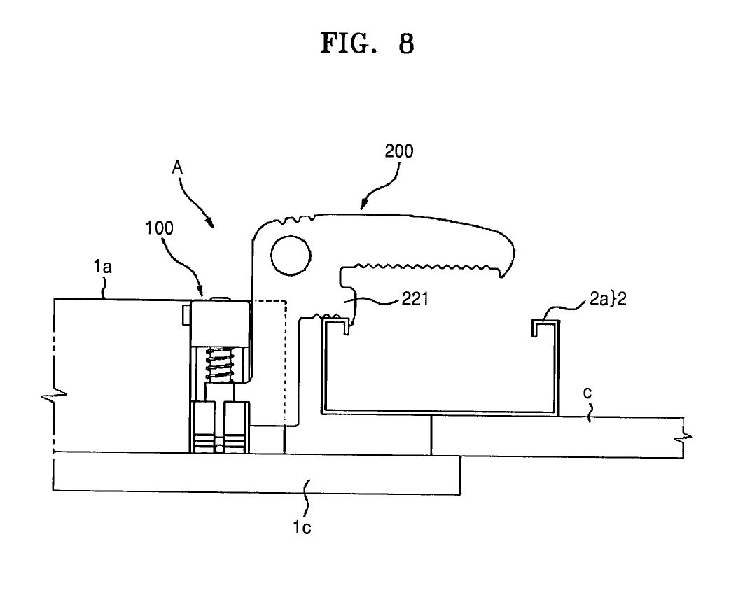

FIG. 1 shows a structure of a lamp 1 to which a lamp fastening device A according to an exemplary embodiment of the inventive concept is provided, and FIGS. 2 through 6 show structures of the lamp fastening device A according to the present exemplary embodiment. FIG. 7 is a plan view showing a structure in which the lamp 1 to which the lamp fastening device A is assembled is fixed into an installation hole of a ceiling.

Referring to FIGS. 1 and 7, the lamp 1 to which the lamp fastening device A is provided is a general light emitting diode (LED) lamp that is buried in the ceiling a, the lamp 1 includes a main body 1a of a box shape that is opened downward, and an LED module (not shown) mounted on a plurality of LED substrates in the main body 1a. A light transmission cover 1a that transmits light is coupled to a lower portion of the main body 1a, which is opened, and a frame 1c is provided on a boundary of the lower portion of the main body 1a.

The lamp 1 is buried in the installation hole b so that the frame 1c is hooked and supported by the installation hole b that is provided in the ceiling a, and the lamp fastening device A according to the present exemplary embodiment is provided on the frame 1c of the lamp 1 so that the lamp 1 buried in the installation hole b is hooked onto a ceiling channel 2 around the installation hole b to be fixed. Reference numeral c denotes a ceiling material provided as a panel.

The lamp 1 may include various kinds of lamps that are installed on the ceiling surface, in addition to the above described LED lamp and a flat type LED lamp that is formed flat, provided that the lamp 1 is hooked onto the ceiling channel 2 via the lamp fastening device A and fixed.

As shown in FIGS. 2 through 6, the lamp fastening device A according to the present exemplary embodiment includes a housing 100 that is to be fixed on the lamp 1, and an operating member 200 provided on the housing 100 to be hooked onto the ceiling channel 2 to fix the lamp 1 on the ceiling a.

The housing 100 is formed of a hollow barrel and is stood on the lamp 1 in a horizontal state to be fixed. In addition, the operating member 200 includes a shaft portion 210 provided in the housing 100 to be rotatable and elevatable, and a hook portion 220 extending to outside of the housing 100 and rotating with the shaft portion 210 to be hooked onto an upper portion of the ceiling channel 2.

A side opening 111 is formed in a circumferential side of the housing 100. A first support surface 112 is disposed on an opposite side of the side opening 111 to be supported by a side surface of the main body 1a of the lamp 1. A second support surface 113 is disposed on a lower portion of the housing 100 to be supported by the frame 1c of the lamp 1. The first and second support surfaces 112 and 113 are hidden by the main body 1a and the frame 1c of the lamp 1 in a state where the housing 100 is fixed on the lamp 1, and thus, the first and second support surfaces 112 and 113 include openings for saving a material forming the housing 100. Therefore, the housing 100 is formed as a hollow barrel having openings in the lower end that becomes the second support surface 113, the circumferential side in which the side opening 111 is formed, and another circumferential side that becomes the first support surface 112. The first and second support surfaces 112 and 113 may be designed to be selectively closed, and an open portion in the second support surface 113 becomes a tool insertion hole 114 that will be described later.

A plurality of protrusions 115 are disposed on a boundary of the first support surface 112, and the protrusions 115 slide to be inserted in a sliding recess 1d formed as a rail on a side surface 1a of the lamp 1 to fix the housing 100 on the main body 1a of the lamp 1. Unlike the above description, the protrusions 115 may be formed on a boundary of the second support surface 113, and the sliding recess 1d by which the protrusions 115 are hooked and fixed may be formed on the frame 1c. Then, the housing 100 may be fixed to the frame 1c of the lamp 1 via the lower end portion thereof.

To simplify the structure of the lamp fastening device A, the operating member 200 may be a single component in which the shaft portion 210 that is installed inside the housing 100 and the hook portion 220 located on the outside the housing 100 are integrally formed with each other. To do this, the shaft portion 210 and the hook portion 220 may be integrally connected to each other via a connection portion 230. The operating member 200 is one component, in which the shaft portion 210, the connection portion 230, and the projection 22 are integrally formed wth each other, and the operating member 200 may be manufactured by a die casting method using a mold.

The connection portion 230 of the operating member 200 includes a horizontal connection portion 231 extending from a side of the lower portion of the side surface of the shaft portion 210 in a horizontal direction (lateral direction), and a vertical connection portion 232 extending upward from an end portion of the horizontal connection portion 231 in a vertical direction (an elevation direction of the shaft portion 210). The hook portion 220 extends from the vertical connection portion 230 in the horizontal direction. The hook portion 220 includes a plurality of hook boards 221 and 222 that are arranged in parallel with each other along a lengthwise direction of the vertical connection portion 232 so as to be hooked onto upper portions of the ceiling channel 2 which may be of various types and have different heights and shapes. In the present exemplary embodiment, the hook boards 221 and 222 form a pair including a first hook board 221 on a lower portion and a second hook board 222 on an upper portion. The plurality of hook boards 221 and 222 are formed as a step-type projection structure, in which an extension length of the second hook board 222 on the upper portion is longer than that of the first hook board 221 on the lower portion.

In order to increase a force of hooking the hook portion 220 by the ceiling channel 2, lower portions of the first and second hook boards 221 and 222, which directly contact the upper portion of the ceiling channel 2, respectively include rough portions 221a and 222a for increasing frictional forces of the hook boards 221 and 222. In addition, a hole 232a is disposed on an upper portion of the vertical connection portion 232 so that a safety cable (not shown) that is provided in the ceiling a may be hooked thereto.

In addition, when installing the operating member 200 on the housing 100, the shaft portion 210 enters the housing 100 through the opened lower portion of the housing 100, and a slit 116 that is connected to the side opening 111 is disposed in a side wall of the housing 100 under the side opening 111 so that the connection portion 230 may pass therethrough when the shaft portion 210 enters the housing 110. Therefore, the operating member 200 is in a rotatable state with respect to the housing 100 based on the shaft portion 210, in a state where the connection portion 230 is located in the side opening 111 after passing through the slit 116.

Also, a guide hole 117 is disposed in an upper end of the housing 100 so as to guide an elevation operation of the shaft portion 210, and an upper end of the shaft portion 210 is inserted into the guide hole 117 when the shaft portion 210 enters the housing 100 so that the rotation and elevation operations of the shaft portion 210 may be guided by the guide hole 117.

Rotation restriction recesses 118 for restricting the rotation operation of the operating member 200 are disposed in side walls of the housing 100 at opposite sides of the slit 116. The rotation restriction recesses 118 support the operating member 200 so that the operating member 200 may not escape from the housing 100 through the slit 116. To do this, the rotation restriction recesses 118 may be formed so that the connection portion 230 may be hooked onto the rotation restriction recesses 118 when the connection portion 230 is dislocated from the slit 116 due to the rotation of the operating member 200 in a state where the connection portion 230 is inserted in the housing 100 via the slit 116 and located in the side opening 111. In the present embodiment, a pair of rotation restriction recesses 118 are provided. One of the pair of the rotation restriction recesses 118 (first rotation restriction recess) restricts the rotation operation of the operating member 200 that is in the rotated state so as to be unhooked from the ceiling channel 2, and the other (second rotation restriction recess) restricts the rotation operation of the operating member 200 that is in the rotated state so as to be hooked onto the ceiling channel 2. The pair of rotation restriction recesses 118 may be arranged at a 180° angle to each other; however, the inventive concept is not limited to the arrangement interval (angle) between the pair of rotation restriction recesses 118.

Therefore, the operating member 200 that is allowed to rotate by locating the connection portion 230 in the side opening 111 is rotated and descended so that the connection portion 230 is hooked by one of the pair of rotation restriction recesses 118, and then, the rotation operation of the operating member 200 is in the restricted state. Also, in a state where the rotation operation is restricted, when the operating member 200 is elevated so that the connection portion 230 is released from the rotation restriction recess 118, the operating member 200 is switched to the rotation allowable state again. A length of each of the rotation restriction recesses 118 is designed so as to restrict the rotation operation of the operating member 200 in a state where the hook portion 220 is hooked onto the ceiling channel 2 having various heights.

A driver recess (tool recess) 212a is disposed on a lower end of the shaft portion 210, and the opening in the second support surface 113 on the lower end of the housing 100, which corresponds to the driver recess 212a, forms the tool insertion hole 114 to which the driver (tool) is inserted. A through hole 1e is formed in the frame 1c, to which the lamp fastening device A is fixed, so as to be connected to the tool insertion hole 114.

Therefore, when the lamp 1 is installed on or separated from the ceiling a, an operator located in indoor space inserts the driver into the housing 100 through the through hole 1e and the tool insertion hole 114 so as to insert a blade of the driver into the driver recess 212a on the lower end of the shaft portion 210. In the above state, the operator may easily manipulate the elevation and rotation operations of the shaft portion 210 so that the hook portion 220 of the operating member 200 may be hooked or unhooked onto the ceiling channel 2, only by pushing or rotating the driver.

In the present embodiment, an engraved flat-tip driver recess is shown as an example of the tool recess 212a; however, the inventive concept is not limited thereto. That is, a shape of the tool recess is not specifically limited, provided that the operating member 200 may be elevated and rotated by using the tool recess. The tool recess may have various shapes, for example, a cross shape and a triangle shape, and may be embossed type.

Also, the lamp fastening device A includes an elastic member 300 that elastically supports the operating member 200 in a direction in which the shaft portion 210 is descended from the housing 100. That is, the elastic member 300 provides the operating member 200 with an elastic force in a direction in which the hook portion 220 presses the ceiling channel 2. In a state where the operating member 200 is elastically supported to downward of the housing 100 by the elastic member 300, the hooking force of the hook portion 220 with respect to the ceiling channel 2 is improved. Moreover, the descending operation of the operating member 200 that is elevated to be assembled with the housing 100 and to be hooked onto or unhooked from the ceiling channel 2 may be automatically performed by an elastic restoring force of the elastic member 300. Also, in a state where the hook portion 220 hooked onto the ceiling channel 2 is elastically supported by the elastic member 300, external shock that is transmitted to the lamp 1 may be buffered by the elastic member 300, and thus, the lamp 1 may be protected against the external shock.

As an example, the elastic member 300 may be a compression coil spring that is assembled in the housing 100 in a state of surrounding the shaft portion 210. The shaft portion 210 of the operating member 200 may include a smaller diameter portion 211 having a smaller diameter so that the elastic member 300 may be inserted therein, and a larger diameter portion 212 having a greater diameter than that of the smaller diameter portion 211 so as to support the lower end of the elastic member 300 inserted in the smaller diameter portion 211. The shaft portion 210 under the larger diameter portion 212, which has the driver recess 212a on the lower end thereof, may have an extended diameter so as to be supported by an inner side surface of the housing 100. In addition, in a state where the shaft portion 210 is inserted in the housing 100, the upper end of the elastic member 300 is supported by the upper inner surface of the housing 100 around the guide hole 117.

Therefore, when assembling the operating member 200 with the housing 100, the elastic member 300 is inserted to the smaller diameter portion 211 of the shaft portion 210, and then, the shaft portion 210 in the above state enters the housing 100 from the lower end of the housing 100. In this state, the connection portion 230 of the operating member 200 is hooked by one of the pair of the rotation restriction recesses 118 and fixed, and accordingly, the operating member 200 is assembled with the housing 100 so as not to escape from the housing 100 in a state of being elastically supported by the elastic member 300 in a descending direction.

FIG. 7 shows a fixing structure of the lamp 1 on which the lamp fastening devices A are installed. Here, each of the lamp fastening devices A is installed on each corner of the lamp 1, and the operating member 200 of each lamp fastening device A is hooked by one of the rotation restriction recesses 118 and in a rotation-restricted state so as not to hooked onto an installation hole b. In the lamp 1 in the above state, the main body 1a enters the installation hole b so that the frame 1c is hooked onto the boundary of the installation hole b, and the operator located in indoor space manipulates the lamp fastening device A by using the driver so that the hook portion 220 of the lamp fastening device A may be hooked onto the ceiling channel 2 around the installation hole b.

First, the operator inserts the driver into the housing 100 via the through hole 1e formed around the corner of the frame 1c so that the blade of the driver is fitted into the driver recess 212a on the lower end of the shaft portion 210. In this state, when the operator elevates the shaft portion 210 by pushing the driver into the housing, the connection portion 230 escapes from the rotation restriction recess 118 and is located toward the side opening 111. Accordingly, the operating member 200 is allowed to rotate. In this state, the operator rotates the driver so that the operating member 200 is rotated toward the other rotation restriction recess 118. The operating member 200 is rotated until the connection portion 230 is located above the other rotation restriction recess 118, and in this state, the elastic member 300 maintains a compressed state.

Through the above rotating process, the operating member 200 passes over the slit 116, and then, the connection portion 230 of the operating member 200 that is rotating may be hooked by the slit 116 due to the elastic restoring force of the elastic member 300. A protrusion if is formed on the frame 1c of the lamp 1 to a height of the slit 116 so as to support the lower end of the connection portion 230 that is located above the slit 116, and thus, the connection portion 230 may be prevented from being hooked by the slit 116 during rotating the operating member 200.

When the operator pulls the driver out through the lower portion of the through hole 1e in a state where the operating member 200 is rotated so that the hook portion 220 is located on the ceiling channel 2, the operating member 200 is descended by the elastic restoring force of the elastic member 300 so that the connection portion 230 is hooked by the other rotation restriction recess 118. In this state, the hook portion 220 is hooked by the ceiling channel 2 in a state where the rough portions 221a or 222a contact the upper portion of the ceiling channel 2. Each of the lamp fastening devices A is hooked and fixed by the adjacent ceiling channel 2 through the above described manipulation processes, and then, the fastening operation of the lamp 1 is finished.

As described above, the lamp fastening device A according to the present embodiment has a very simplified structure including the housing 100, the operating member 200, and the elastic member 300 respectively forming a single body. In addition, the lamp 1 may be commonly hooked onto and fixed on various kinds of ceiling channels 2 through simple rotation and elevation processes of the operating member 200.

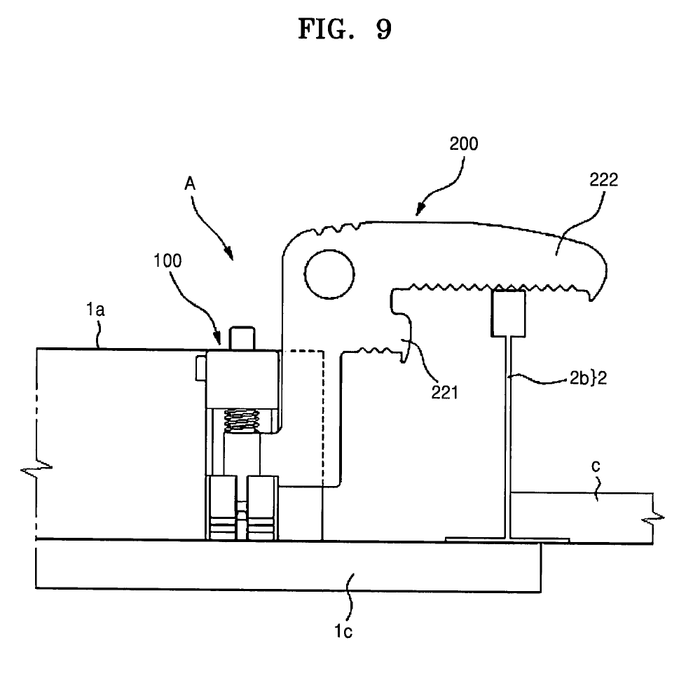

FIGS. 8 though 10 show structures in which the lamp fastening device A fixed on the lamp 1 is hooked onto and fixed on the ceiling channels 2 having various shapes and heights.

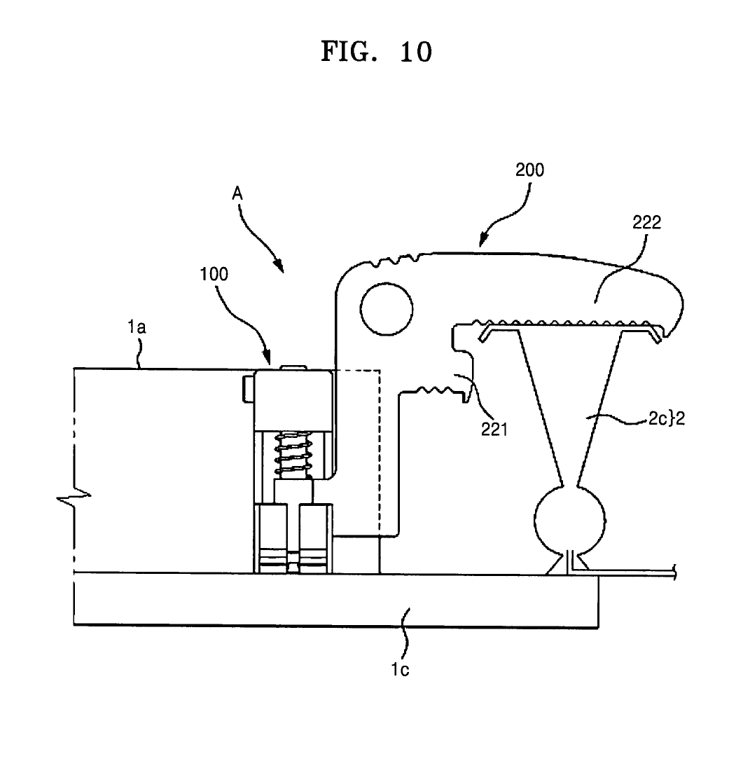

In FIG. 8, an M-bar ceiling channel 2a has a cross-section formed as an inversed M shape, and in FIG. 9, a T-bar ceiling channel 2b has a cross-section formed as an inversed T shape. In addition, in FIG. 10, a clip-bar ceiling channel 2c is formed as a clip.

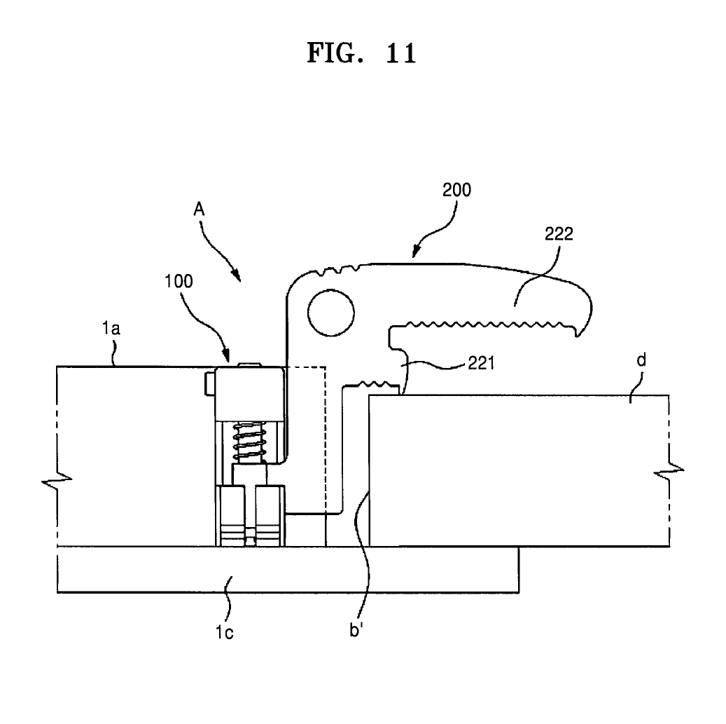

As described in the drawings, the ceiling channel 2 has various shapes and heights. However, the lamp fastening device A according to the present embodiment may freely adjust the height of the hook portion 220 hooked onto the ceiling channel 2 by using the elevation structure of the operating member 200 and the multiple hook structure of the hook portion 220, and thus, the lamp 1 may be commonly hooked and fixed on the ceiling channels 2 of various types. The lamp fastening device A may fix the lamp 1 on the ceiling of a simple structure such as wood wall d without using the ceiling channel 2, in the same way as above. As shown in FIG. 11, the lamp fastening device A may fix the lamp 1 on the ceiling by directly hanging the operating member 200 around an installation hole b′ formed in the wood wall d.

Also, the lamp fastening device A may be applied to fix the lamp 1 on the ceilings of various types, for example, a drywall ceiling, a plasterboard, and a galvanizing steel.

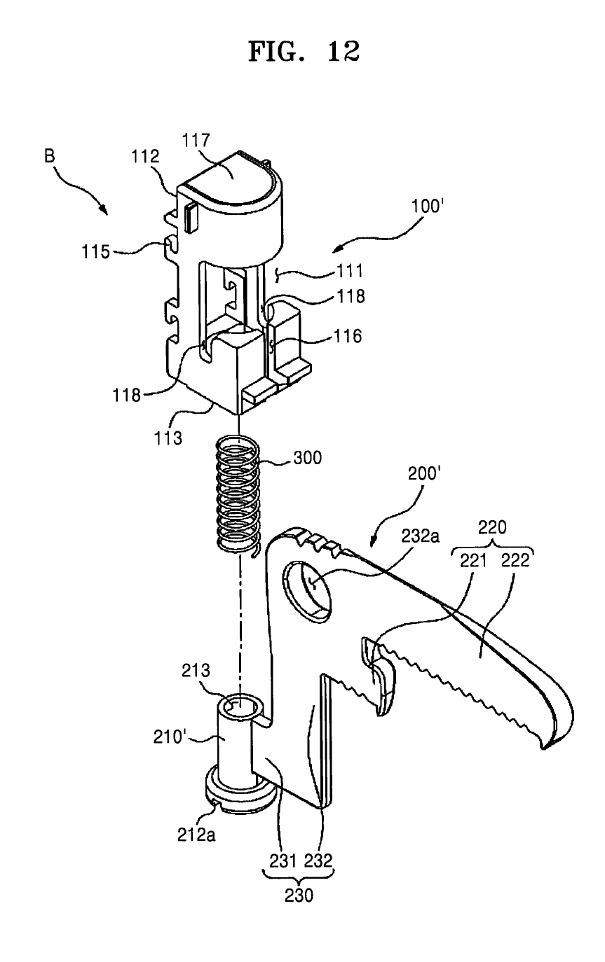

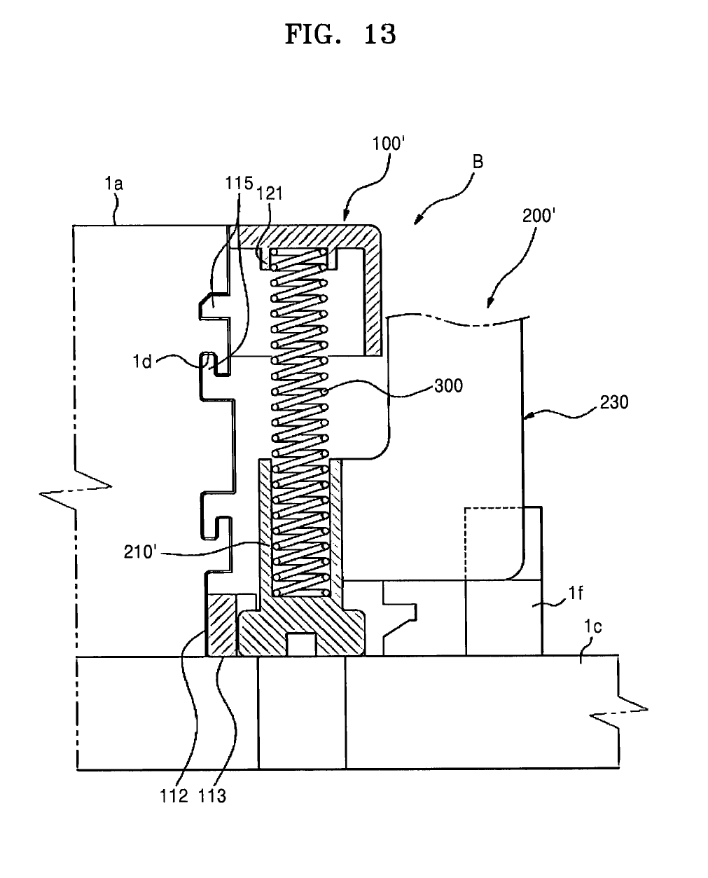

In addition, FIGS. 12 and 13 show a lamp fastening device B according to another exemplary embodiment of the inventive concept.

As shown in FIGS. 12 and 13, an operating member 200′ is shorter than a housing 100′ so that a shaft portion 210′ thereof may be elevated only in the housing 100′, and thus, a consumption amount of the material may be reduced. In addition, the elastic member 300, that is, a compression spring, is assembled in the housing 100′ so that an upper end thereof is supported by an upper inner surface of the housing 100′ and a lower end thereof is supported by an upper portion of the shaft portion 210′.

The shaft portion 210′ stably rotates and elevates in a state of being supported by the inner surface of the housing 100′. A support recess 213 is formed in an upper end of the shaft portion 210′ so that the lower end of the elastic member 300 may be stably supported by the upper portion of the shaft portion 210′, and the lower end of the elastic member 300 is inserted and mounted in the support recess 213 to be supported by the shaft portion 210′.

A fixing protrusion 121 for fixing a support position on the upper portion of the elastic member 300 may be disposed in an upper portion of the housing 100′. The fixing protrusion 121 is formed as a ring protruding downward that fixes the upper boundary of the elastic member 300 when the operating member 200′ is assembled and the shaft portion 210′ enters the housing 100′, and thus, dislocation of the upper end of the elastic member 300 may be prevented.

In the lamp fastening device B according to the present embodiment, other elements except for the shaft portion 210′ of the operating member 200′ and the installation structure of the elastic member 300 are the same as those of the lamp fastening device A according to the previous embodiment.

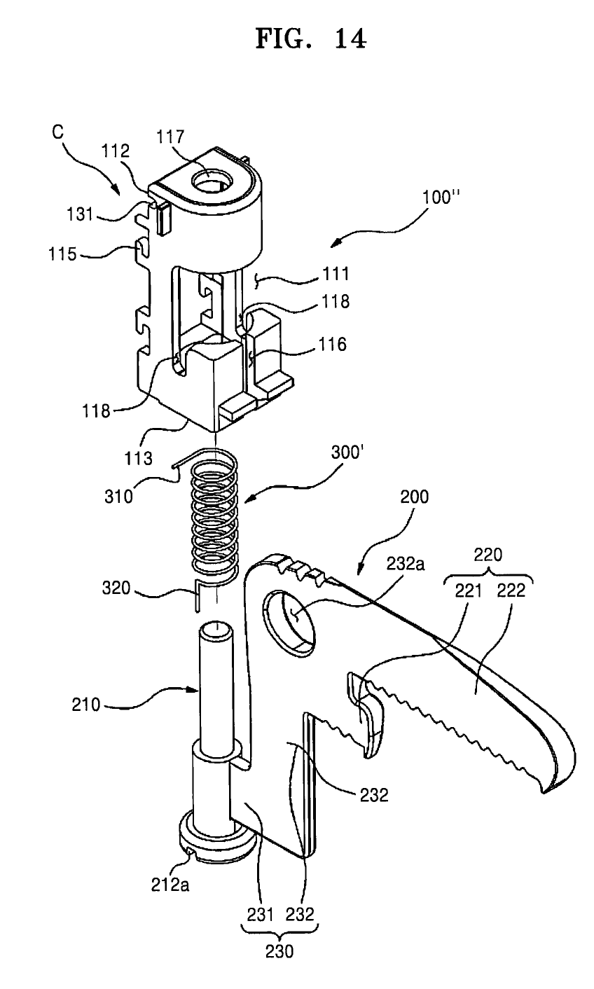

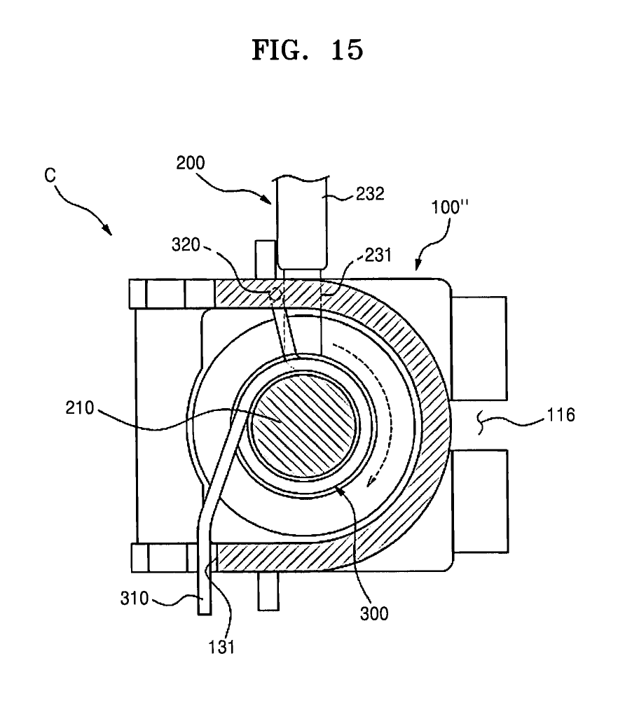

FIGS. 14 and 15 show a structure of a lamp fastening device C according to another exemplary embodiment of the inventive concept, and the lamp fastening device C of the present embodiment performs an operation of rotating the operating member 200 that is rotated in a direction automatically to opposite direction.

To do this, an elastic member 300′ of the lamp fastening device C is disposed so as to apply the compression restoring force in an extending direction from a compressed state. In addition, the elastic member 300′ is provided so that an end is hooked onto a housing 100″ and the other end is hooked onto the operating member 200, and thus, in a state where the elastic member 300′ is twisted between the opposite ends thereof, the restoring force generated by releasing the twist allows the operating member 200 to rotate. That is, the elastic member 300′ applies an elastic force to the operating member 200 in a direction in which the hook portion 220 presses the ceiling channel 2, and applies an elastic force to the operating member 200 for rotating the hook portion 220 in one of a direction, in which the hook portion 220 is switched to the hooked state by the ceiling channel 2, and a direction, in which the hook portion 220 is unhooked from the ceiling channel 2. In the present embodiment, the elastic member 300′ applies the elastic force to the operating member 200 in a direction, in which the hook portion 220 is switched to the hooked state by the ceiling channel 2.

In the present embodiment, the elastic member 300′ may be a compression spring (torsion-compression-spring) having an upper end (upper arm) 310 supported by the housing 100″ and a lower end (lower arm) 320 supported by the operating member 200. The upper and lower ends 310 and 320 may be located in the same direction as each other along the circumference of the elastic member 300 in a state where the elastic member 300′ is not twisted.

In the above state, when the operating member 200 is rotated in a direction, the elastic member 300′ is twisted between the upper and lower ends 310 and 320 thereof in the circumferential direction of the elastic member 300′, and then, the rotation restoring force is applied to a direction in which the twisted state is released. Then, the operating member 200 obtains the rotary force from the rotation restoring force of the elastic member 300′.

Therefore, as shown in FIG. 15, the lamp fastening device C may be mounted to the lamp 1 in a state where the connection portion 230 is hooked by one rotation restriction recess 118 so as not to rotate and a rotation restoring force is generated by the elastic member 300′. The lamp fastening device C in the above state may automatically perform the projecting operation of the operating member 200 because the operating member 200 may be rotated toward the ceiling channel 2 by the rotation restoring force of he elastic member 300′ by simply performing the operation of elevating the shaft portion 210 so that the connection portion 230 may escape from the rotation restriction recess 118.

That is, when the operator elevates the shaft portion 210 by using the driver, the connection portion 230 escapes from one rotation restriction recess 118 and the operating member 200 is allowed to rotate. Accordingly, the operating member 200 is rotated toward the other rotation restriction recess 118 along an arrow direction of FIG. 14 by the rotation restoring force of the elastic member 300′. While the operating member 200 rotates, the elastic member 300′ maintains its compressed state in the length direction. The operating member 200 rotates to the upper portion of the other rotation restriction recess 118 along the side opening 111, and in this state, the operating member 200 is descended by an extension restoring force of the elastic member 300′ that has been compressed so that the connection portion 230 may be hooked by the other rotation restriction recess 118. Then, the hook portion 220 may be hooked onto the ceiling channel 2.

In the present embodiment, the upper end 310 of the elastic member 300′ extends in the radial direction so as to be supported by the projection recess 131 formed in the first support surface 112 of the housing 100″, and the lower end 320 of the elastic member 300′ extends downward along the lengthwise direction of the elastic member 300′ so as to be supported by the horizontal extension unit 231 of the connection portion 230 of the operating member 200, so that the elastic member 300′ between the opposite ends thereof may be twisted according to the rotating direction of the operating member 200.

The above embodiments show examples in which the lamp is fixed to the ceiling by using the lamp fastening devices A, B, and C, but the lamp fastening devices A, B, and C according to the embodiments of the inventive concept may be applied as fastening devices for fixing various apparatuses installed on the ceiling, for example, a speaker, a ventilator, an air conditioning system, an electric fan, a communication router, a closed circuit TV (CCTV), a camera for CCTV, a projector, an air cooler/heater, a TV, and an air purifier on the ceiling channel 2.

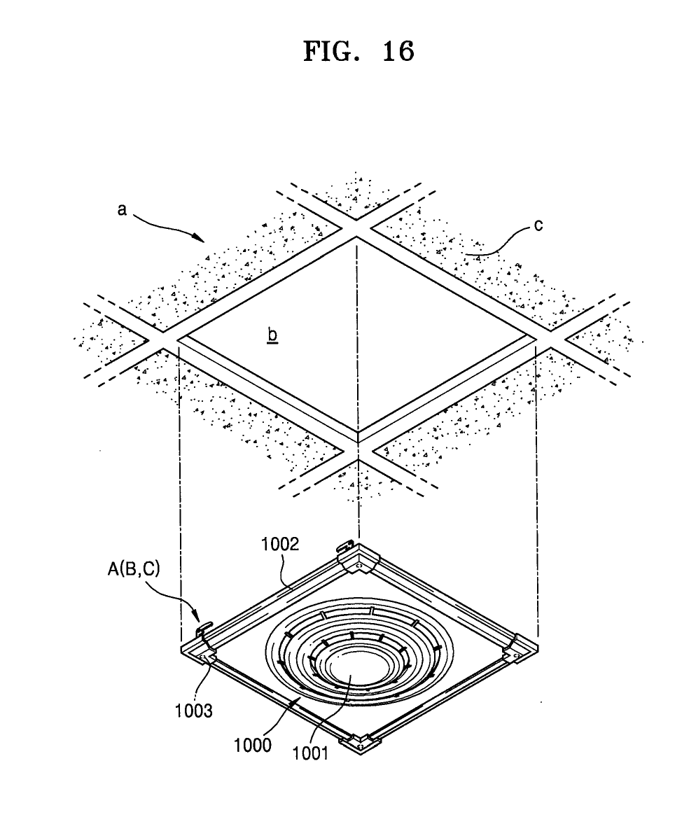

For example, FIGS. 16, 17, and 18 show examples of fixing a ventilator 1000, an air cooler/heater 2000, and a speaker 3000 respectively to the ceiling channel 2 by using the fastening devices A, B, and C shown in FIGS. 1 through 15. Referring to FIG. 16, a ventilator main body 1001 is mounted on a frame 1002 of the ventilator 1000. The main body 1001 may be a discharge hole connected to a duct (not shown) in the ceiling to discharge air supplied via the duct, or an inlet for intaking air into the duct. Also, the main body 1001 may include a fan (not shown) for inhaling and/or discharging air and a motor for driving the fan therein. The fastening device A, B, or C is fixed on the frame 1002 or the main body 1001. For example, four fastening devices A, B, or C may be mounted on the frame 1002 or the main body 1001. The frame 1002 may include a through hole 1003 for making a tool, for example, the driver (not shown), access the tool recess 212a formed in the shaft portion 210 of the operating member 200. Processes of installing the ventilator 1000 on the ceiling channel 2 by using the above configuration are the same as the above processes of fixing the lamp 1, and thus, repeated descriptions are omitted.

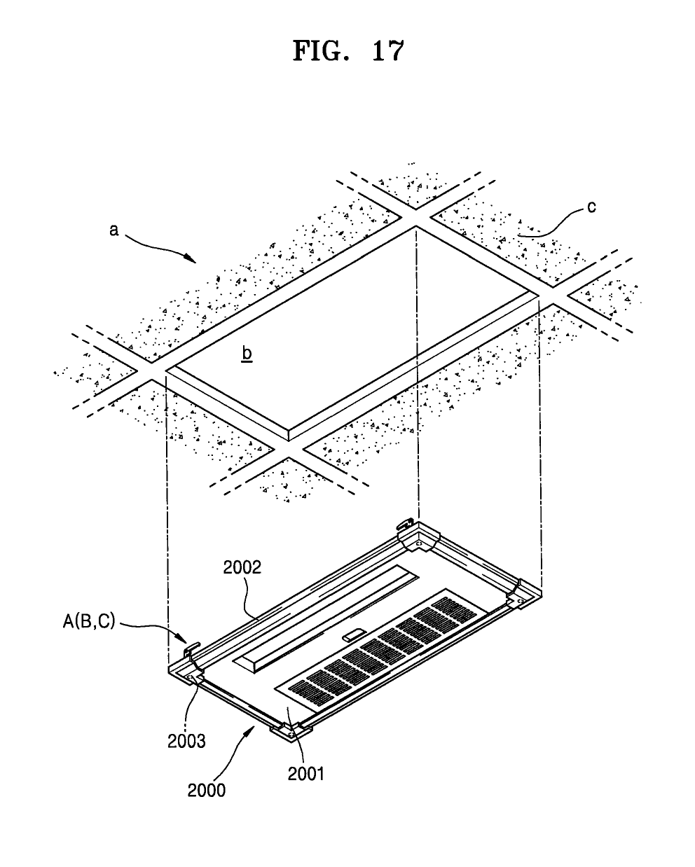

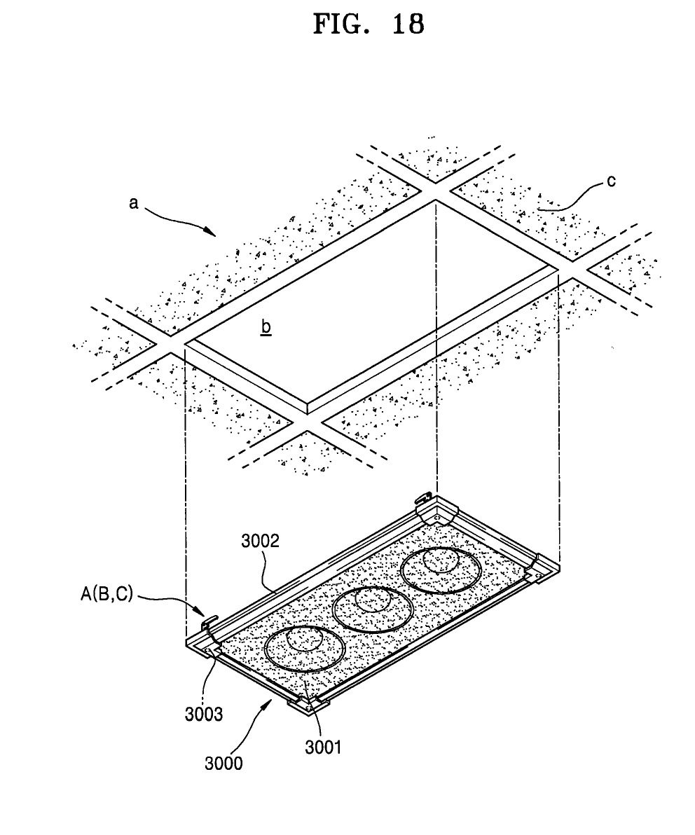

In FIG. 17, reference numerals 2000, 2001, 2002, and 2003 denote an air cooler/heater, a main body of the air cooler/heater, a frame, and a through hole, and in FIG. 18, reference numerals 3000, 3001, 3002, and 3003 denote a speaker, a main body of the speaker, a frame, and a through hole, respectively. Processes of fixing the air cooler/heater 2000 and the speaker 3000 to the ceiling channel are the same as the above processes of fixing the lamp 1, and thus, repeated descriptions are omitted. In the above embodiments, the frames 1c, 1002, 2002, and 3002 are integrally formed with the lamp 1, the ventilator 1000, the air cooler/heater 2000, and the speaker 3000, respectively. However, one or more embodiments of the inventive concept are not limited thereto. For example, the frames 1c, 1002, 2002, or 3002 matched with the shape of the installation hole b may be an element of the fastening device A, B, or C. In this case, the main body 1a, 1001, 2001, and 3001 may be fixed on the frames 1c, 1002, 2002, and 3002. That is, the main body 1a, 1001, 2001, and 3001 are mounted on the fastening device A, B, or C including the frame 1c, 1002, 2002, and 3002, and then, the entire assembly may be fixed on the ceiling channel 2.

While this invention has been particularly shown and described with reference to preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and it is to be appreciated that all changes, equivalents, and substitutes that do not depart from the spirit and technical scope of the present invention are encompassed in the present invention.

### INDUSTRIAL APPLICABILITY

The inventive concept may be applied as a fastening device for fixing various apparatuses including lamp, for example, a speaker, a ventilator, an air conditioning system, an electric fan, a communication router, a closed circuit TV (CCTV), a camera for CCTV, a projector, an air cooler/heater, a TV, and an air purifier on a ceiling channel.

1. A lamp fastening device for fixing a lamp on a ceiling channel, the lamp fastening device comprising:
a housing formed as a hollow container that is fixed on the lamp and having a side opening between opposite ends thereof;
an operating member comprising a shaft portion provided in the housing to be rotatable and elevatable, and a hook portion extending from the shaft portion to outside of the housing through the side opening to be hooked onto the ceiling channel according to a rotating operation of the shaft portion; and
an elastic member for providing the operating member with an elastic force in a direction in which the hook portion presses the ceiling channel.

2. The lamp fastening device of claim 1, wherein a tool recess to which a tool for rotating the operating member is coupled is formed in a lower end of the shaft portion, and a tool insertion hole for inserting the tool into the housing is formed in a lower end of the housing, which corresponds to the tool recess.

3. The lamp fastening device of claim 1, wherein the shaft portion comprises a smaller diameter portion into which the elastic member is inserted, and a larger diameter portion having a greater diameter than the smaller diameter portion to support a lower end of the elastic member, a guide hole for guiding an elevation operation of the shaft portion is disposed in an upper end of the housing, and an upper end of the elastic member is supported by an upper inner surface of the housing around the guide hole.

4. The lamp fastening device of claim 1, wherein the operating member further comprises a connection portion for connecting the shaft portion to the hook portion, the shaft portion enters the housing through the lower end of the housing, and a side wall of the housing includes a slit that is connected to the side opening so that the connection portion may pass therethrough when the shaft portion enters the housing from the lower end of the housing.

5. The lamp fastening device of claim 4, wherein a pair of rotation restriction recesses are disposed in the side wall of the housing at opposite sides of the slit so that the connection portion is inserted therein from the side opening in order to restrict the rotating operation of the operating member, and one of the pair of rotation restriction recesses restricts the rotating operation of the operating member that is in an unhooked state where the operating member is released from the ceiling channel, and the other of the pair of rotation restriction recesses restricts the rotating operation of the operating member that is in a hooked state where the operating member is hooked onto the ceiling channel.

6. The lamp fastening device of claim 1, wherein the hook portion includes a plurality of hook boards that are disposed in an elevating direction of the shaft portion and are respectively hooked onto the ceiling channels that are of different types, and an uppermost hook board from among the plurality of hook boards in the elevating direction has the longest extending length.

7. The lamp fastening device of claim 1, wherein the shaft portion and the hook portion of the operating member are integrally formed with each other.

8. The lamp fastening device of claim 1, wherein the housing comprises at least one support surface supported by a surface of the lamp in a state of being fixed on the lamp and opened to outside.

9. The lamp fastening device of claim 1, wherein the shaft portion is shorter than the housing and is elevated in the housing, the elastic member comprises a compression spring installed in the housing in a length direction of the housing so that an upper end thereof is supported by the upper inner surface of the housing and a lower end thereof is supported by the shaft portion, and the lower end of the elastic member is inserted into a support recess formed in the upper end of the shaft portion.

10. The lamp fastening device of claim 1, wherein the elastic member applies an elastic force to the operating member for rotating the operating member in one of a direction in which the hook portion is to be hooked onto the ceiling channel and a direction in which the hook portion is to be unhooked from the ceiling channel.

11. A fastening device for fixing an apparatus to a ceiling channel, the fastening device comprising:
a housing formed as a hollow container that is fixed on the apparatus and having a side opening between opposite ends thereof;
an operating member comprising a shaft portion provided in the housing to be rotatable and elevatable, and a hook portion extending from the shaft portion to outside of the housing through the side opening and switched to a state of being hooked onto the ceiling channel and to a state of being unhooked from the ceiling channel according to a rotating operation of the shaft portion; and
an elastic member for providing the operating member with an elastic force in a direction in which the hook portion presses the ceiling channel.

12. The fastening device of claim 11, wherein a tool recess to which a tool for rotating the operating member is coupled is formed in a lower end of the shaft portion, and a tool insertion hole for inserting the tool into the housing is formed in a lower end of the housing, which corresponds to the tool recess.

13. The fastening device of claim 11, wherein the operating member further comprises a connection portion for connecting the shaft portion to the hook portion, the shaft portion enters the housing through the lower end of the housing, and a side wall of the housing includes a slit that is connected to the side opening so that the connection portion may pass therethrough when the shaft portion enters the housing from the lower end of the housing.

14. The fastening device of claim 13, wherein a rotation restriction recesse is provided in the housing so that the connection portion is inserted therein from the slit in order to restrict the rotating operation of the operating member.

15. The fastening device of claim 14, wherein the rotation restriction recess comprises a first rotation restriction recess for restricting the rotating operation of the operating member that is unhooked from the ceiling channel.

16. The fastening device of claim 15, wherein the rotation restriction recess comprises a second rotation restriction recess for restricting the rotating operation of the operating member that is hooked onto the ceiling channel.

17. The fastening device of claim 14, wherein the operating member escapes from the rotation restriction recess by being elevated in a direction opposite to the direction of the elastic force of the elastic member to rotate to a state of being hooked onto the ceiling channel and a state of being unhooked from the ceiling channel.

18. The fastening device of claim 11, wherein the hook portion includes a plurality of hook boards that are disposed in an elevating direction of the shaft portion and are respectively hooked onto the ceiling channels that are of different types, and an uppermost hook board from among the plurality of hook boards in the elevating direction has the longest extending length.

19. The lamp fastening device of claim 11, wherein the elastic member applies an elastic force to the operating member for rotating the operating member in one of a direction in which the hook portion is to be hooked onto the ceiling channel and a direction in which the hook portion is to be unhooked from the ceiling channel.

20. A fastening device for fixing an apparatus to a ceiling channel, the fastening device comprising:
a frame, to which a main body of the apparatus is mounted, having a shape corresponding to a shape of an installation hole of a ceiling;
a housing fixed on the frame;
an operating member comprising a shaft portion provided in the housing to be rotatable and elevatable, and a hook portion extending from the shaft portion and switched to a state of being hooked onto the ceiling channel and to a state of being unhooked from the ceiling channel according to a rotating operation of the shaft portion; and
an elastic member for providing the operating member with an elastic force in a direction in which the hook portion is compressed toward the ceiling channel, wherein a tool recess is formed in a lower end of the shaft portion, a lower end of the housing is opened to expose the tool recess, and a through hole is formed in the frame so that a tool for elevating and rotating the operating member is coupled to the tool recess.
